(19) United States
(12) Patent Application Publication
(10) Pub. No.: US 2011/0278865 A1
(43) Pub. Date: Nov. 17, 2011

(54) Door Latch

(76) Inventor: Gerald G. Ryan, JR., Oak Creek, WI (US)

(21) Appl. No.: 12/780,976

(22) Filed: May 17, 2010

(51) Int. Cl. E05B 1/00

(52) U.S. Cl. 292/336.3

(57) ABSTRACT

A door latch includes two handles, two handle housings and a link shaft. Each handle includes a handle member and a handle shaft extending from the handle. Each handle housing includes a housing base, a housing shaft and two ball bearings. The two ball bearing are pressed on to each end of the housing shaft. The two ball bearings and the housing shaft are retained in the housing base. A handle housing opening is formed through each side of a door to receive the first and second handle housings. The two housing shafts are secured to the link shaft. A roller is preferably secured to an end of the handle for contact with a door frame. An optional lock may be retained on one of the handles to prevent an authorized opening of the door.

### BACKGROUND OF THE INVENTION

1. Field of the Invention

The present invention relates generally to securing doors and more specifically to a door latch, which includes reduced rotational resistance.

2. Discussion of the Prior Art

U.S. Pat. No. 6,354,119 to Molzer discloses a handle and lock. The Molzer patent includes a base having an index pin, a stop positioned in a circular channel, and an aperture traversing the base. A shaft is rotatably engaged to the base. The shaft includes a nut-shaped platform and an arcuate positioning limiter disposed in the circular working channel. The handle generally includes a head portion having a nut shaped receiving area and an arcuate protruding positioning member for placement within the circular working channel. The shaft further includes a latch member designed to engage a latch receiver integral to a door frame used for latching of a door in a closed position.

Accordingly, there is a clearly felt need in the art for a door latch, which includes reduced rotational resistance.

### SUMMARY OF THE INVENTION

The present invention provides a door latch, which includes reduced rotational resistance. The door latch includes two handles, two handle housings and a link shaft. Each handle includes a handle member and a handle shaft. The handle member preferably includes a substantially rectangular perimeter and the handle shaft extends from the substantially rectangular perimeter. Each handle housing includes a housing base, a housing shaft and two ball bearings. The handle base preferably includes a first housing half and a second housing half. Each housing half includes a flange half and a shaft retainer half. The shaft retainer half extends from one side of the flange half. A shaft clearance cavity is formed in the shaft retainer half to receive the housing shaft and two ball bearings.

The housing shaft preferably includes a first shaft half and a second shaft half. Each shaft half includes a first bearing shoulder and a second bearing shoulder. A fastener clearance cavity is formed in the shaft half to receive a link fastener. The first and second shaft halves are assembled by pressing the first and second bearings around thereof, until the first and second bearings contact the first and second shoulders, respectively. A handle housing opening is formed through a door to receive a first and second handle housing. The link shaft includes a first female threaded end and a second female threaded end for threadably receiving first and second link fasteners.

The link shaft is secured to secured to one end of a first handle housing with a first link fastener. The first handle housing is inserted into a first handle housing opening. The second handle housing is inserted into a second handle housing opening. The second handle housing is secured to the link with the second link fastener. An optional lock may be retained on one of the handles to prevent an authorized opening of the door. A roller is preferably secured to an end of the handle for contact with a door frame.

Accordingly, it is an object of the present invention to provide a door latch, which includes reduced rotational resistance.

These and additional objects, advantages, features and benefits of the present invention will become apparent from the following specification.

### BRIEF DESCRIPTION OF THE DRAWINGS

FIG. 1 is a partially exploded perspective view of a door latch in accordance with the present invention.

FIG. 2 is a perspective view of a handle of a door latch in accordance with the present invention.

FIG. 3 is an exploded perspective view of a handle housing of a door latch in accordance with the present invention.

FIG. 4 is a perspective view of a housing half of a handle housing of a door latch in accordance with the present invention.

FIG. 5 is a perspective view of a shaft half of a housing shaft of a door latch in accordance with the present invention.

FIG. 6 is an end view of a link shaft of a door latch in accordance with the present invention.

FIG. 7 is a perspective view of a link shaft of a door latch in accordance with the present invention.

FIG. 8 is a cross sectional view of a link shaft of a door latch in accordance with the present invention.

FIG. 9 is an exploded perspective view of a roller of a door latch in accordance with the present invention.

FIG. 10 is an exploded perspective view of a tool lock of a door latch in accordance with the present invention.

FIG. 11 is a perspective view of a lock housing of a door latch in accordance with the present invention.

FIG. 12 is an exploded perspective view of a key lock of a door latch in accordance with the present invention.

FIG. 13 is an end view of a lock housing of a door latch in accordance with the present invention.

FIG. 14 is a side view of a lock housing of a door latch in accordance with the present invention.

FIG. 15 is a cross sectional view of a lock housing secured to a handle of a door latch in accordance with the present invention.

FIG. 16 is a cross sectional view of a door retained in a door in accordance with the present invention.

### DETAILED DESCRIPTION OF THE PREFERRED EMBODIMENTS

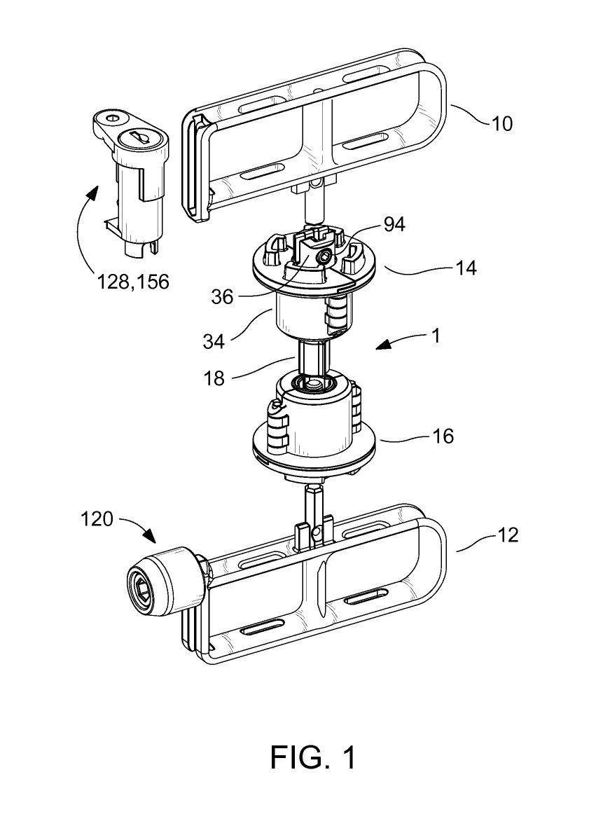

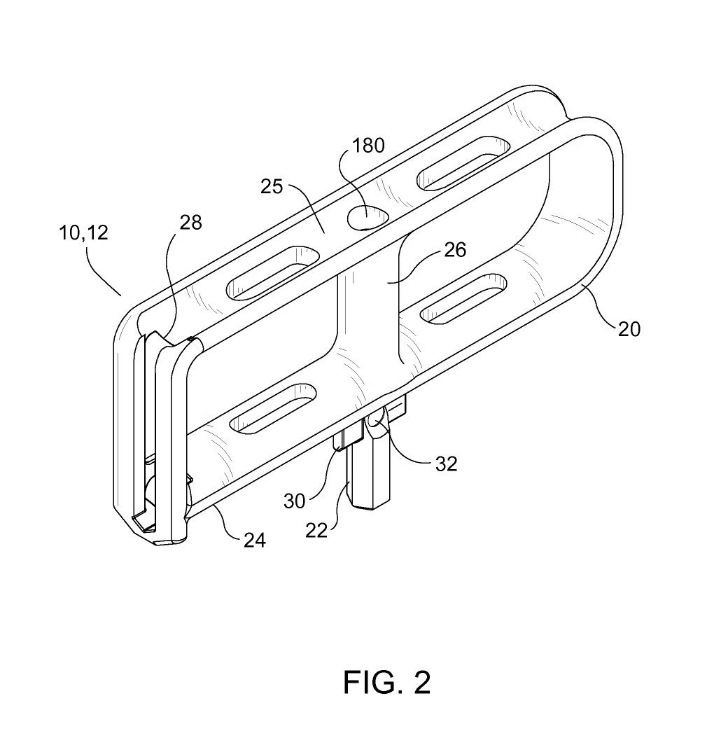

With reference now to the drawings, and particularly to FIG. 1, there is shown an exploded perspective view of a door latch 1. With reference to FIG. 2, the door latch 1 includes a first handle 10, a second handle 12, a first handle housing 14, a second handle housing 16 and a link shaft 18. Each handle 10, 12 includes a handle member 20 and a handle shaft 22. The handle member 20 preferably includes a substantially rectangular perimeter 24 and a center support strut 26. The substantially rectangular perimeter preferably includes a concave cavity 25. The center support strut 26 is located in a middle of the substantially rectangular perimeter 24. A bolt slot 28 is formed in one end of the substantially rectangular perimeter 24 to receive a hex bolt or other suitable fastener. The handle shaft 22 extends from the substantially rectangular perimeter 24. The handle shaft 22 preferably has a hex cross-section, but other suitable cross sections may also be used. A lock support wing 30 extends from the substantially rectangular perimeter 24 and from both sides of the handle shaft 22. A set screw cavity 32 is formed in the handle shaft 22, between the two lock support wings 30.

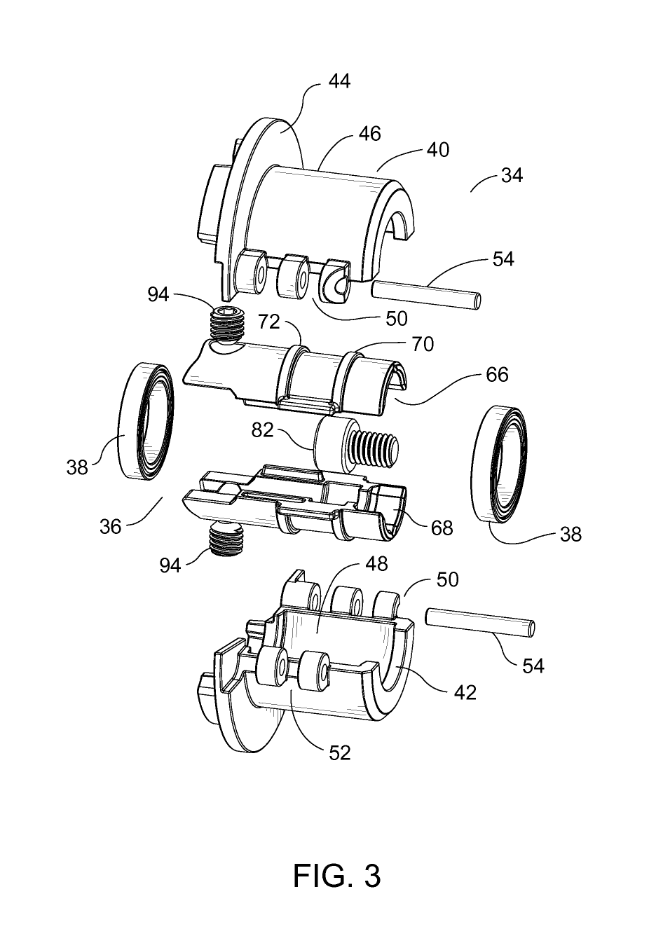

With reference to FIGS. 3-4, each handle housing 14, 16 includes a housing base 34, a housing shaft 36 and two ball bearings 38. The housing base 34 preferably includes a first housing half 40 and a second housing half 42. Each housing half 40 includes a flange half 44 and a shaft retainer half 46. The shaft retainer half 46 extends from a rear of the flange half 44. A shaft clearance cavity 48 is formed in the shaft retainer half 46 to receive the housing shaft 36 and two ball bearings 38. Preferably, a first set of hinge members 50 extend from one side of the housing half 40 and a second set of hinge members 52 extend from an opposing side of the housing half 40. The first and second set of hinge members on the first housing half 40 are positioned to receive a second and first set of hinge members on the second housing half 42. A retention pin 54 is inserted through the first and second set of hinge members to secure the first housing half 40 to the second housing half 42. However, other methods of securing the first housing half 40 to the second housing half 42 may also be used.

A pair of lock projections 56 extend from a front of the flange half 44. A front shaft opening 58 is formed through the flange half 44 to provide clearance for a front of the housing shaft 36. The flange half 44 also retains one of the two ball bearings 38 in the housing half 40. A rear bearing shoulder 60 is formed on a rear of the housing half 40, 42 to retain the other one of the two ball bearings 38. A rear shaft opening 62 is formed through the rear bearing shoulder 60 to provide clearance for a rear of the housing shaft 36. A plurality of rotation stops 64 are formed into the shaft clearance cavity 48 to limit rotation of the housing shaft 36 relative to the housing base 34 for preferably 90 degrees, but other angles may also be used.

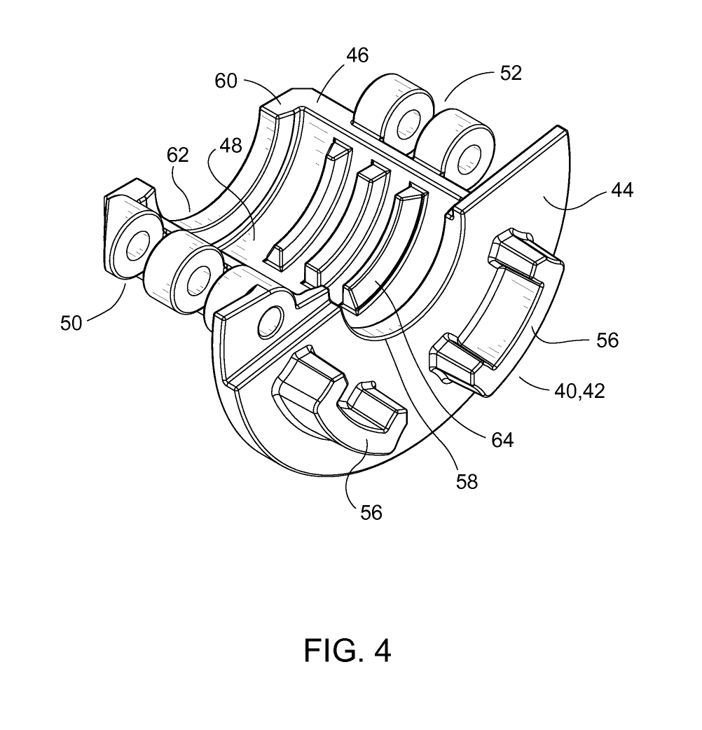

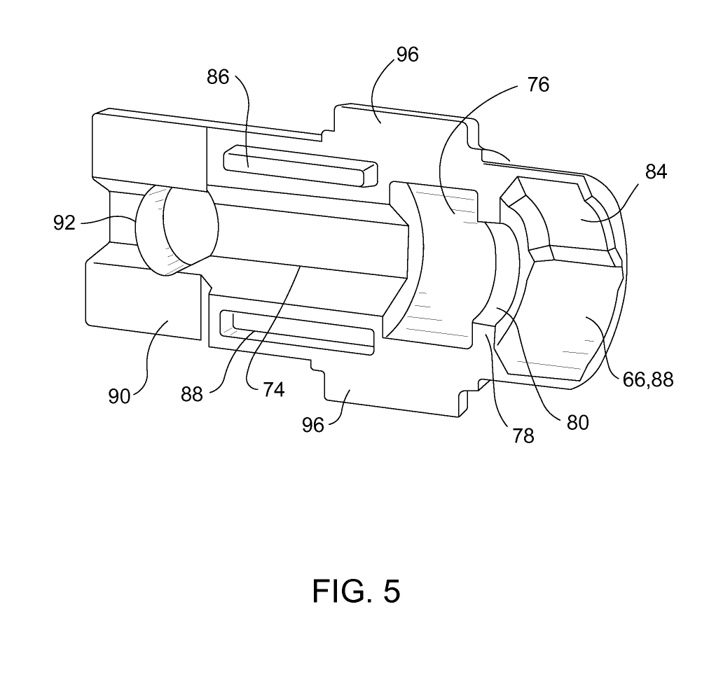

With reference to FIG. 5, the housing shaft 36 preferably includes a first shaft half 66 and a second shaft half 68. Each shaft half 66 includes a first bearing shoulder 70 and a second bearing shoulder 72. A handle shaft cavity 74 is formed through substantially a length of the shaft half 66 to receive the handle shaft 22. The handle shaft cavity 74 includes a cross-section with one half the contour of the handle shaft 22. One end of a fastener clearance cavity 76 terminates an end of the handle shaft cavity 74. A fastener shoulder 78 terminates the other end of the fastener clearance cavity 76. A fastener clearance opening 80 is formed in the fastener shoulder 78. The fastener shoulder 78 provides support for a head of a link fastener 82 and the fastener clearance opening 80 provides clearance for the threads of the link fastener 82.

A link cavity 84 is formed in an end of the shaft half 66 to receive the link shaft 18. The link cavity 84 includes half the contour of the link shaft 18. An assembly projection 86 is formed on one side of the handle shaft cavity 74 and an assembly cavity 88 is formed on the other side of the handle shaft cavity 74. The assembly projection 86 and the assembly cavity 88 on the first shaft half 66 are positioned to receive the assembly projection 86 and the assembly cavity 88 on the second shaft half 68. The assembly projection 86 and assembly cavity 88 locate the first and second shaft halves for assembly. The first and second shaft halves are assembled by pressing the ball bearings 38 on each end thereof, until the first and second ball bearing contacts the first and second bearing shoulders, respectively. However, other methods of locating the first and second shaft halves relative to each other may also be used.

The link fastener 82 is inserted between the first and second shaft halves before assembly. A clamping recess 90 is preferably formed across a front end of the shaft half 66. A set screw tap 92 is formed through the front end of the shaft half 66 to threadably receive a set screw 94. A rotation projection 96 extends from opposing sides of the shaft half 66. The plurality of rotation stops 64 only allow rotation of the housing shaft 36 to a predetermined angle by contact with the rotation projections 96.

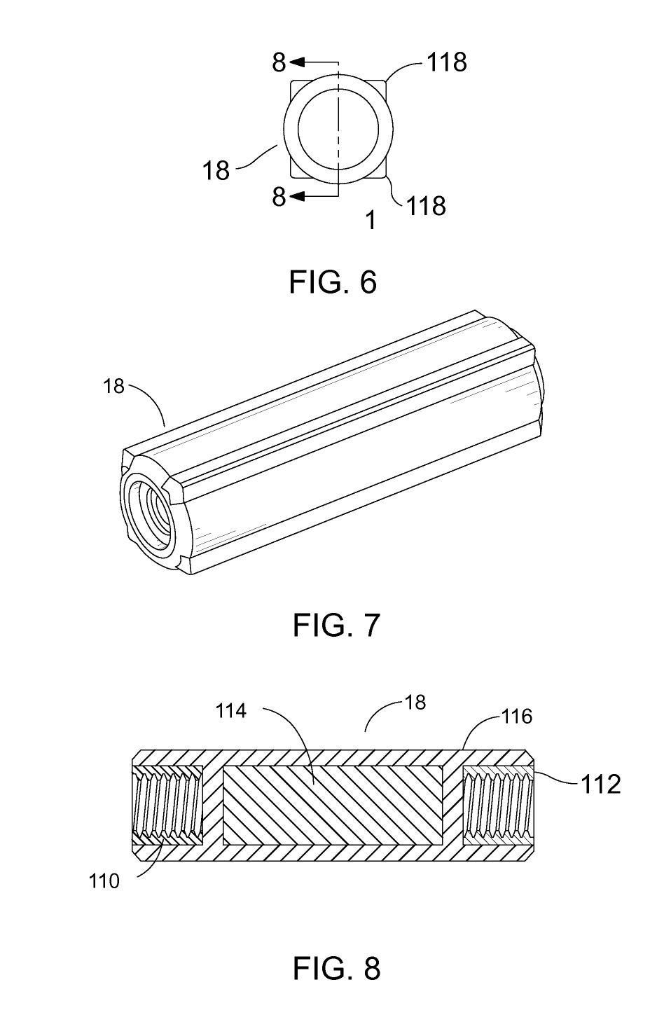

With reference to FIGS. 6-8, the link shaft 18 preferably includes a first threaded insert 110, a second threaded insert 112 and a middle insert 114, which are all preferably fabricated from a metal, such as steel. An outer over-molded surface 116 is fabricated from a durable plastic. The outer over-molded surface 116 preferably includes a round cross section with a plurality of anti-rotation projections 118 extending from an outside perimeter thereof.

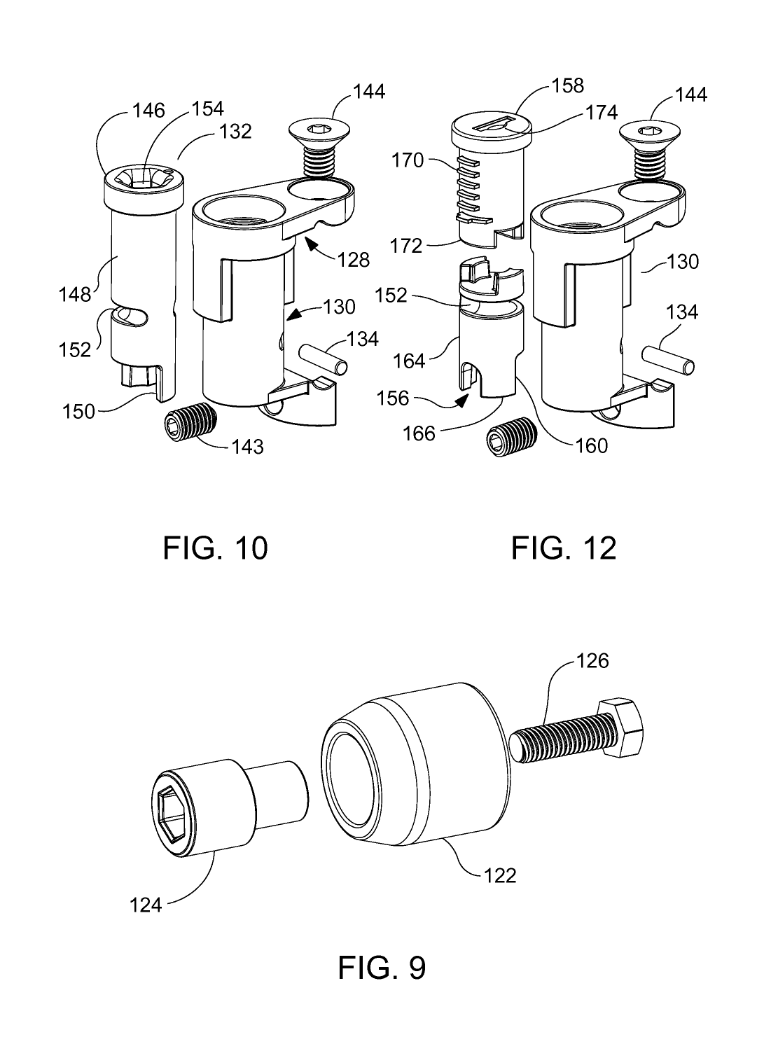

With reference to FIG. 9, a roller 120 includes a roller tire 122, a retention nut 124 and a threaded fastener 126. The roller 120 is retained on the second handle 12 by inserting a head of the threaded fastener 126 into the bolt slot 28. The roller tire 122 is inserted over the threaded fastener 126 and the retention nut 124 is tightened onto the threaded fastener 126 to rotatably retain the roller tire 122 relative to the second handle 12.

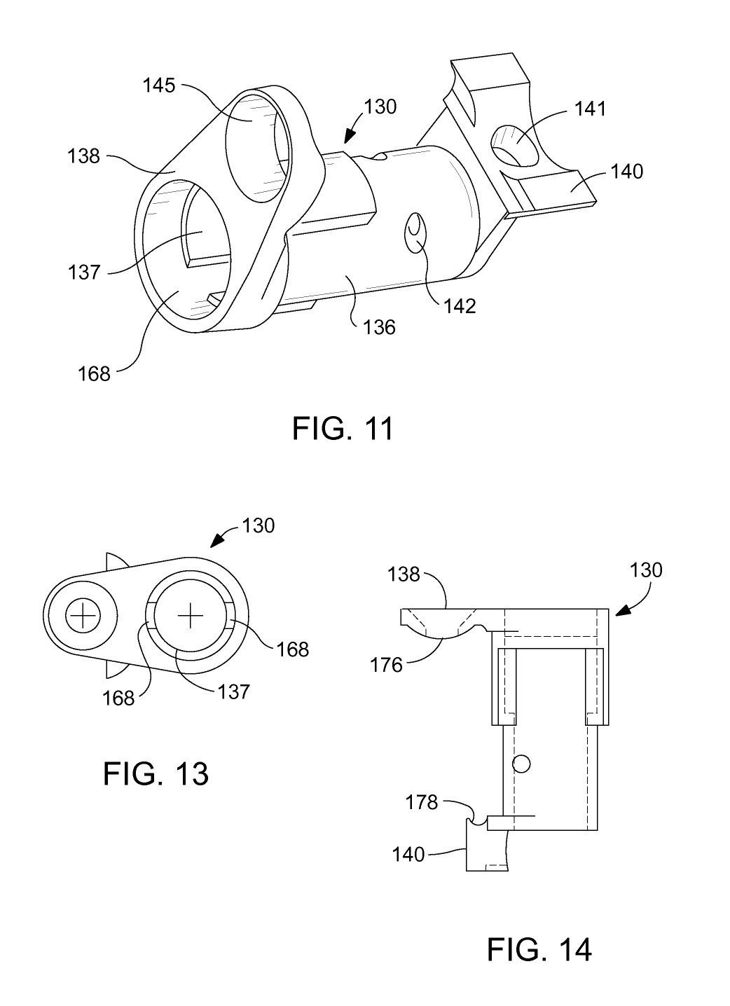

With reference to FIGS. 10-11, a tool lock 128 includes a lock housing 130, a tool lock cam 132 and a lock pin 134. The lock housing 130 includes a cam cylinder 136, an attachment flange 138 and a support projection 140. A threaded tap 141 is formed through the support projection 140 to threadably receive a set screw 143. The attachment flange 138 extends from one end of the cam cylinder 136 and the support projection 140 extends from the other end of the cam cylinder 136. The lock housing 130 is attached to the first handle 10 with a lock fastener 144. A pin retaining hole 142 is formed through the cam cylinder 136 for insertion of the lock pin 134. The tool lock cam 132 is retained in a cam bore 137 of the cam cylinder 136 with the lock pin 134.

The tool lock cam 132 includes a drive head 146, a cylindrical body 148 and a pair of locking fingers 150. A pin groove 152 is formed in the cylindrical body 148 to receive the lock pin 134. A tool cavity 154 is formed in the drive head 146 to receive a tool, such as an allen wrench. The plurality of lock projections 56 extending from the housing base 34 prevent the first handle 10 from being rotated, when the pair of locking fingers 150 are rotated to be in between a pair of lock projections 56.

With reference to FIGS. 12-13, a key lock 156 includes a lock housing 130, a key lock 158, a key lock cam 160 and the lock pin 134. The key lock cam 160 is retained in the cam bore 137 of the cam cylinder 136 with the lock pin 134. A pair of opposing key slots 168 are formed along a length of the cam bore 137 to receive a plurality of retention projections 170 extending from at least one side of the key lock 158. The key lock 158 is pressed fitted in the cam bore 137 and prevented from rotation by the plurality of retention projections 170. The key lock cam 160 includes a drive cavity 162, a cylindrical body 164 and a pair of locking fingers 166. A pin groove 152 is formed in the cylindrical body 148 to receive the lock pin 134. The drive cavity 162 is sized to receive a pair of key lock fingers 172 extending from an end of the key lock 158. Rotation of a key (not shown) inserted into the key receiver 174 causes the pair of key lock fingers 172 to rotate, which results in the rotation of the key lock cam 160. The plurality of lock projections 56 extending from the housing base 34 prevent the first handle 10 from being rotated, when the pair of locking fingers 166 are rotated to be in between a pair of lock projections 56.

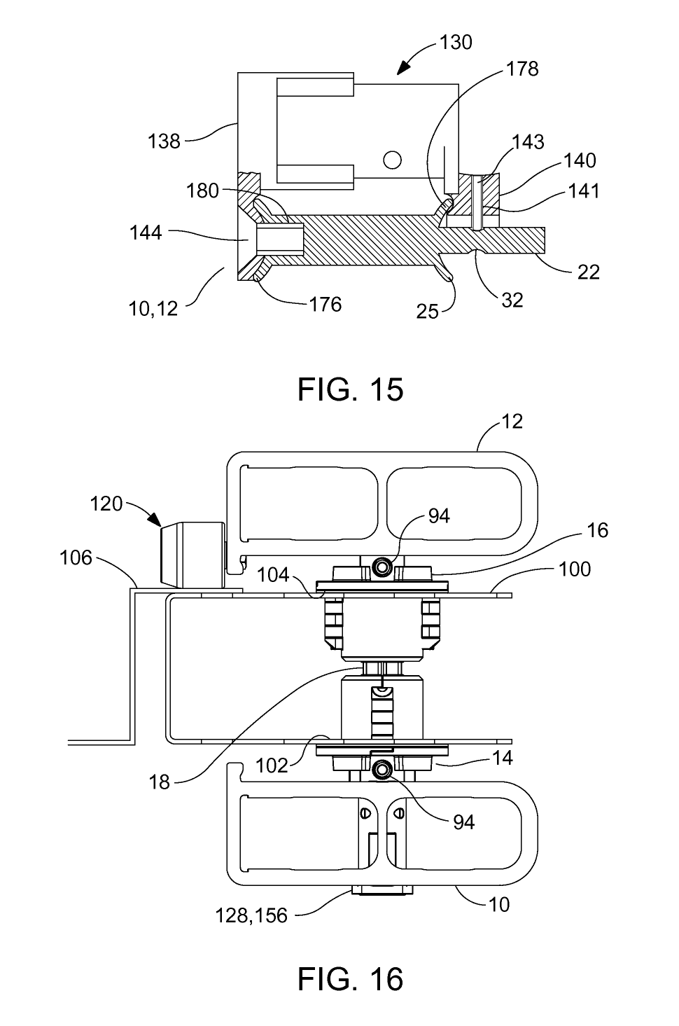

With reference to FIG. 14, a convex projection 176 extends from an inside surface of the attachment flange 138. The convex projection 176 is sized to be received by the concave cavity 25 of the handle 10, 12. A lock lip 178 extends from an inside end of the support projection 140. The lock lip 178 is sized to hook into an edge of the concave cavity 25. With reference to FIG. 15, the lock housing 130 is slid from the other end of the handle 10, 12, until it is positioned over center support strut 26. The lock fastener 144 is inserted through the fastener hole 145 and tightened in a threaded hole 180 in the handle 10, 12. The set screw 143 is located concentric with the set screw cavity 32 and is tightened in the threaded tap 141, until the lock lip 178 is secured against the edge of the concave cavity 25. However, the use of the tool lock 128 or the key lock 156 with the handle 10, 12 is optional.

With reference to FIG. 16, a first handle housing opening 102 is formed through a door 100 to receive the first handle housing 14 and a second handle housing opening 104 is formed through the door 100 to receive the second handle housing 16. The link shaft 18 is secured to an end of the first handle housing 14 with the link fastener 82. The first handle housing 14 is inserted into first handle housing opening 102. The second handle housing 16 is inserted into the second handle housing opening 104. The second handle housing 16 is secured to the link shaft 18 with the link fastener 82. The handle shafts 22 of the first and second handles 10, 12 are inserted into the first and second housing shafts and secured thereto with two set screws 94. The tool lock 128 or the key lock 156 may be attached to the first handle 10. The roller 120 may be adjusted relative to the second handle 12 for contact with a door frame 106 along the bolt slot 28.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

I claim:

1. A door latch comprising:
a first handle having a first handle shaft extending therefrom;
a first handle housing having a first housing base, a first housing shaft and two first ball bearings, said two first ball bearings are retained on each end of said first housing shaft, said first housing shaft and said two first ball bearings are retained in said first housing base, said first handle shaft is retained in one end of said first housing shaft;
a second handle having a second handle shaft extending therefrom;
a second handle housing having a second housing base, a second housing shaft and two second ball bearings, said two second ball bearings are retained on each end of said second housing shaft, said second housing shaft and said two second ball bearings are retained in said second housing base, said second handle shaft is retained in one end of said second housing shaft; and
a link shaft having one end for securement to the other end of said first housing shaft, the other end of said link shaft for securement to the other end of said second housing shaft.

2. The door latch of claim 1 wherein:
means for limiting the rotation of at least one of said first and second housing shafts relative to at least one of said first and second handle housings.

3. The door latch of claim 2 wherein:
said means for limiting the rotation are at least one projection extending from said housing shaft and at least one projection extending from said housing base.

4. The door latch of claim 1, further comprising:
a lock device for attachment to one of said first and second handle, said lock device preventing rotation between one of said first and second handles and one of said first and second handle housings.

5. The door latch of claim 1, further comprising:
said housing shaft includes a first shaft half and a second shaft half, said first and second shaft halves being retained together with said two ball bearings.

6. The door latch of claim 1, further comprising:
said housing base includes a first housing half and a second housing half, said first and second housing halves are secured to each other to axially retain said housing shaft.

7. The door latch of claim 6 wherein:
said handle including a bolt slot formed in an end of said handle, a roller is adjustable in said bolt slot.

8. A door latch comprising:
a first handle having a first handle shaft extending therefrom;
a first handle housing having a first housing base, a first housing shaft and two first ball bearings, said two first ball bearings are retained on each end of said first housing shaft, said first housing shaft and said two first ball bearings are retained in said first housing base, said first handle shaft is retained in one end of said first housing shaft;
a second handle having a second handle shaft extending therefrom;
a second handle housing having a second housing base, a second housing shaft and two second ball bearings, said two second ball bearings are retained on each end of said second housing shaft, said second housing shaft and said two second ball bearings are retained in said second housing base, said second handle shaft is retained in one end of said second housing shaft;
means for limiting the rotation of at least one of said first and second housing shafts relative to at least one of said first and second handle housings; and
a link shaft having one end for securement to the other end of said first housing shaft, the other end of said link shaft for securement to the other end of said second housing shaft.

9. The door latch of claim 8 wherein:
said means for limiting the rotation are at least one projection extending from said housing shaft and at least one projection extending from said housing base.

10. The door latch of claim 8, further comprising:
a lock device for attachment to one of said first and second handle, said lock device preventing rotation between one of said first and second handles and one of said first and second handle housings.

11. The door latch of claim 8, further comprising:
said housing shaft includes a first shaft half and a second shaft half, said first and second shaft halves being retained together with said two ball bearings.

12. The door latch of claim 8, further comprising:
said housing base includes a first housing half and a second housing half, said first and second housing halves are secured to each other to axially retain said housing shaft.

13. The door latch of claim 8 wherein:
said handle including a bolt slot formed in an end of said handle, a roller is adjustable in said bolt slot.

14. A door latch comprising:
a first handle having a first handle shaft extending therefrom;
a first handle housing having a first housing base, a first housing shaft and two first ball bearings, said two first ball bearings are retained on each end of said first housing shaft, said first housing shaft and said two first ball bearings are retained in said first housing base, said first handle shaft is retained in one end of said first housing shaft;
a second handle having a second handle shaft extending therefrom;
a second handle housing having a second housing base, a second housing shaft and two second ball bearings, said two second ball bearings are retained on each end of said second housing shaft, said second housing shaft and said two second ball bearings are retained in said second housing base, said second handle shaft is retained in one end of said second housing shaft;
a link shaft having one end for securement to the other end of said first housing shaft, the other end of said link shaft for securement to the other end of said second housing shaft; and
a roller is retained on one of said first and second handles.

15. The door latch of claim 14 wherein:
means for limiting the rotation of at least one of said first and second housing shafts relative to at least one of said first and second handle housings.

16. The door latch of claim 15 wherein:
said means for limiting the rotation are at least one projection extending from said housing shaft and at least one projection extending from said housing base.

17. The door latch of claim 14, further comprising:
a lock device for attachment to one of said first and second handle, said lock device preventing rotation between one of said first and second handles and one of said first and second handle housings.

18. The door latch of claim 14, further comprising:
said housing shaft includes a first shaft half and a second shaft half, said first and second shaft halves being retained together with said two ball bearings.

19. The door latch of claim 14, further comprising:
said housing base includes a first housing half and a second housing half, said first and second housing halves are secured to each other to axially retain said housing shaft.
